(19) United States
(12) Patent Application Publication
(10) Pub. No.: US 2015/0082344 A1
(43) Pub. Date: Mar. 19, 2015

(54) INTERIOR PERMANENT MAGNET MOTOR

(71) Applicant: United Video Properties, Inc., Santa Clara, CA (US)

(72) Inventor: Thomas Patrick Antalek, Hermosa Beach, CA (US)

(73) Assignee: United Video Properties, Inc., Santa Clara, CA (US)

(21) Appl. No.: 14/026,764

(22) Filed: Sep. 13, 2013

(51) Int. Cl. H04N 21/466; H04N 21/432; H04N 21/482; H04N 21/45; H04N 21/458; H04N 21/431; H04N 21/433

(52) U.S. Cl. CPC H04N 21/4668; H04N 21/4312; H04N 21/4325; H04N 21/4334; H04N 21/4532; H04N 21/458; H04N 21/4826
USPC 725/34

(57) ABSTRACT

Methods and systems are described herein for a media guidance application that provides content related to a media asset based on occurrences in the media asset. For example, a media guidance application may determine that for a particular media asset (e.g., a recording of a baseball game) that the favorite team of the user lost. In response, because the user's favorite team lost, the media guidance application may retrieve and/or generate a video clip of highlights of the game and delete the original recording of the game.

### BACKGROUND

In conventional systems, users have access to a plethora of media content. For example, a typical user may obtain programming from cable, satellite, and/or Internet sources. Moreover, the advent of DVR's and other methods of storing programming allows users to record and/or store programming for playback whenever the user wishes. However, even though users may have the ability to record and/or store multitudes of programs, users may not have an unlimited amount of time to consume the programs. Furthermore, in some cases, the amount of time a user wishes to devote a particular program may depend on the content of the program.

### SUMMARY

Accordingly, methods and systems are described herein for a media guidance application that provides content related to a media asset based on occurrences in the media asset. For example, a media guidance application may determine that for a particular media asset (e.g., a recording of a baseball game) that the favorite team of the user lost. In response, because the user's favorite team lost, the media guidance application may determine that a user may not wish to watch the entire game. Consequently, the media guidance application may retrieve and/or generate a video clip of highlights of the game and delete the original recording of the game.

In another example, the media guidance application may determine that the user's favorite team won, in response the media guidance application may generate options related to ordering merchandise, updating fantasy sports rosters, recording additional games, etc. as well as providing the recording of the baseball game to the user.

In some aspects, the media guidance application may store a media asset (e.g., in response to a user request to record the media asset) and determine an outcome associated with the media asset. The media guidance application may then cross-reference the outcome of the media asset with a database associated with actions to perform in response to outcomes of media assets to determine whether to provide the stored media asset to a user based on the outcome. Furthermore, in response to determining not to provide the stored media asset to the user based on the outcome, the media guidance application may provide content related to the media asset to the user instead of the stored media asset. For example, instead of providing the stored media asset, the media guidance application may provide highlights associated with the media asset.

In some aspects, the database associated with actions to perform in response to outcomes of media assets may select actions to perform in response to outcomes of media assets in the database based on a user profile. For example, the media guidance application may track a user's favorite team or past actions of the user to determine particular actions the user would prefer in response to particular outcomes.

In some aspects, the media guidance application may determine the outcomes associated with media assets in numerous ways. For example, the media guidance application may receive information related to the outcome of the media asset transmitted with the media asset. For example, metadata associated with the media asset that is a scored contest may indicate a current score and/or whether or not the game is completed. In another example, a real-time data feed associated with the media asset may transmit data indicative of the outcome of the media asset. In another example, the media guidance application may process the media asset using a content recognition module to determine information related to the outcome of the media asset (e.g., the current score as displayed on an on-screen scoreboard) to determine the outcome associated with the media asset.

In some aspects, the media guidance application may provide content related to media assets, in which the media assets are scored contests or non-scored contents. For example, the media guidance application may determine the outcome of a baseball game (e.g., a scored contest) or the media guidance application may determine the outcome of an episode of serial programming (e.g., a non-scored contest). For example, if the media asset is a scored contest (e.g., an episode of a reality television show), the media guidance application may determine an outcome (e.g., a contestant that is eliminated) of the scored contest. The outcome may then be cross-referenced with a database to determine a particular action that media guidance application should perform. If the media asset is a non-scored contest (e.g., an episode of a comedy program), the media guidance application may determine an occurrence of an event (e.g., a plot twist, an appearance of a guest star, etc.) of the non-scored contest. The event may then be cross-referenced with a database to determine a particular action that media guidance application should perform.

It should be noted, the systems and/or methods described above may be applied to, or used in accordance with, other systems, methods and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative media guidance application for accessing media assets in accordance with some embodiments of the disclosure;

FIG. 2 shows another illustrative media guidance application for accessing media assets in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is an illustrative representation of a display used to access content related to a media asset provided by the media guidance application in response to determining an outcome associated with the media asset in accordance with some embodiments of the disclosure;

FIG. 6 is a flowchart of illustrative steps involved in providing content related to the media asset to the user based on an outcome of the media asset in accordance with some embodiments of the disclosure; and

FIG. 7 is a flowchart of illustrative steps involved in determining content related to a media asset to present to a user in response to determining an outcome of the media asset in accordance with some embodiments of the disclosure.

### DETAILED DESCRIPTION OF THE DRAWINGS

Methods and systems are described herein for a media guidance application that provides media content related to a media asset based on occurrences in the media asset. As referred to herein a “media guidance application,” “interactive media guidance application,” or a “guidance application” is an application that provides a form of media guidance through an interface that allows users to efficiently navigate, access, recommend, and view media content.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

As referred to herein, “content related to a media asset” or “related content” may include any content, including other media assets, that are associated with the media asset. For example, content related to the media asset may include media assets such as video clips or highlights related to the media asset, merchandise and/or options to purchase merchandise related to the media asset, options to update a user profile (e.g., a fantasy sports roster and/or any other data related to a fantasy sports league associated with the media asset, user preferences associated with the media asset, etc.), and/or media guidance application operations (e.g., series recordings and/or other recording options associated with the media asset).

In some embodiments, the media guidance application may determine an outcome of a media asset that is a scored contest. As used herein, the term “scored contest” means a media asset featuring competitors or contestants competing for an award(s) and/or goal(s) according to particular rules and/or scoring systems. Scored contests may include sports, game shows, award ceremonies, countdowns, or other events. The competitors in a scored contest may be one or more people, products, services, or ideas. In some embodiments, the media guidance application may also determine an outcome of a media asset that is a non-scored contest. As used herein, the term “non-scored contest” means a media asset that is not a scored contest.

In some embodiments, the media guidance application may process a real-time data feed associated with a media asset to determine an outcome or an event occurring in the media asset. The real-time data feed may include real-time data. As used herein, “real-time data” refers to data received by the media guidance application, which describes the current state (e.g., the score, point of progress, and/or occurrences of events in the media asset) of the media asset. In some embodiments, the real-time data may include information received from other media, recent news, rumors, social media updates and/or posts, recommendations, observations, compilations, and/or correlations of data derived from one or more sources. In some embodiments, the real-time data may be received from the same source as the media content and/or the media guidance application. In some embodiments, the real-time data may be received from a different source than the media content and/or the media guidance application. For example, the real-time data may be received from a real-time data source (e.g., real-time data source 424 (FIG. 4)).

As used herein, the term “outcome,” refers to a particular scenario and/or circumstance resulting at the conclusion of the progression of a scored contest. For example, if the media asset is a scored contest, the scenario and/or circumstance may refer to a particular contestant winning or losing, may refer to a particular contestant achieving a particular score or a particular score relative to another contestant, or may refer to the final standings of the participants in the scored contest. The particular outcome for which a user is interested in may be determined by the user or the media guidance application.

In another example, if the media asset is not a scored contest, the media guidance application may monitor for an occurrence of an event. The event may include a scenario and/or circumstance related to a particular story line or plot point occurring, may refer to a particular rating being achieved (e.g., by a rating system that determines audience viewing habits during the progression of a program such as audience measurement systems developed by the Nielsen Company), may refer to the appearance of particular characters, actors, and/or themes, or may refer to any other characteristic of the program, which may interest the user.

In some embodiments, the media guidance application may determine the particular likelihood of an outcome occurring and perform an action based on the particular likelihood. Performing actions based on particular likelihoods is described in greater detail in Seyller et al. U.S. patent application Ser. No. 13/491,899, filed Jun. 8, 2012, which is hereby incorporated by reference herein in its entirety. For example, to calculate the likelihood, the media guidance application may compare current score information associated with the media asset (e.g., metadata or real-time data) to historical information (e.g., information relating to past scenarios, events, and/or circumstances that may be indicative of current or future scenarios, events, and/or circumstances) to determine the likelihood the media asset will have a particular outcome.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

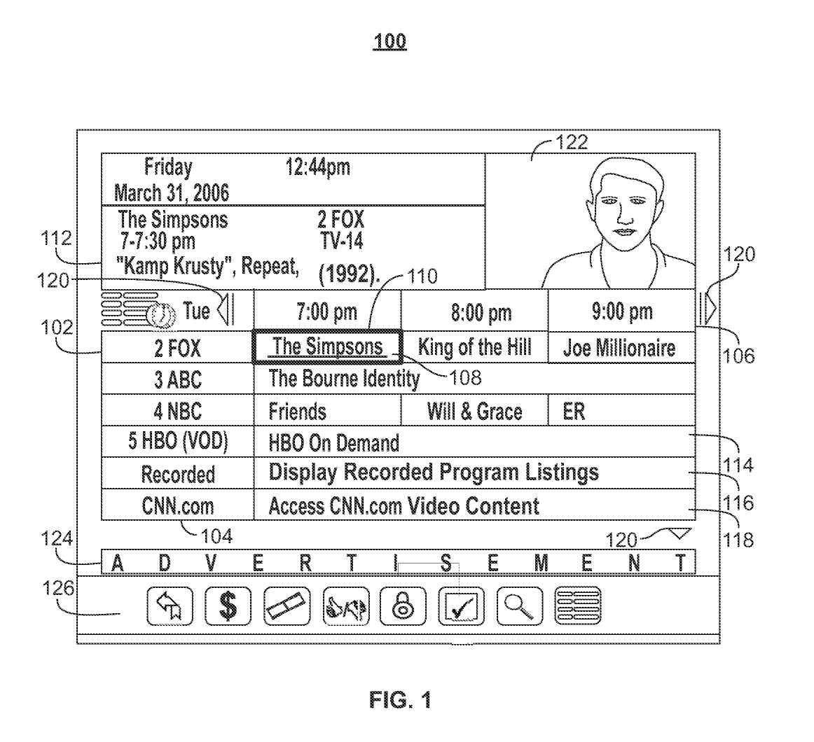

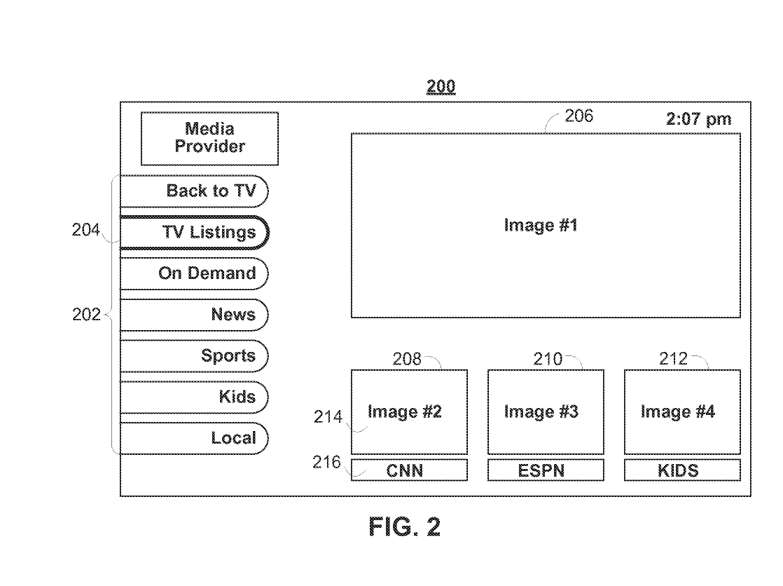

FIGS. 1-2 show illustrative display screens that may be used to provide media guidance data. The display screens shown in FIGS. 1-2 and 5 may be implemented on any suitable user equipment device or platform. While the displays of FIGS. 1-2 and 5 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

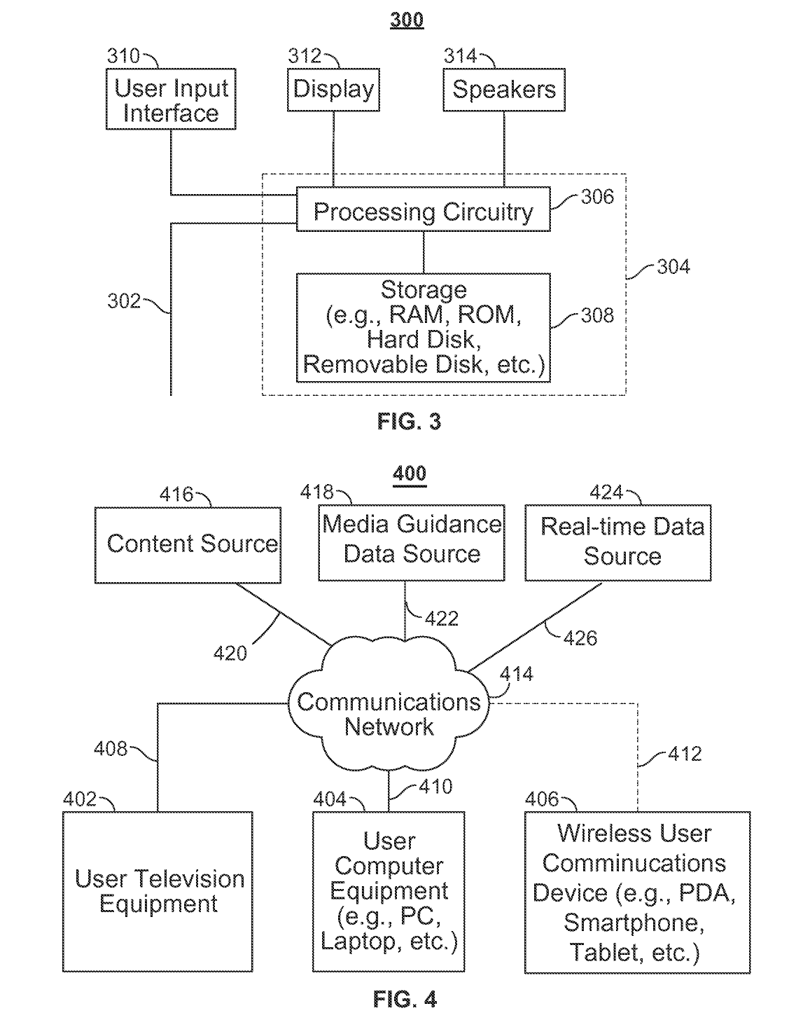

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance information, described above, and guidance application data, described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from an out-of-band feed, from an Internet resource, or using another suitable approach). In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416, media guidance data source 418, and real-time data source 424 coupled to communications network 414 via communication paths 420, 422 and 426, respectively. Paths 420, 422 and 426 may include any of the communication paths described above in connection with paths 408, 410, and 412. Communications with the content source 416, media guidance data source 418, and real-time data source 424 may be exchanged over one or more communications paths, but are shown as a single path in FIG. 4 to avoid overcomplicating the drawing. In addition, there may be more than one of each of content source 416, media guidance data source 418, and real-time data source 424, but only one of each is shown in FIG. 4 to avoid overcomplicating the drawing. (The different types of each of these sources are discussed below.) If desired, content source 416, media guidance data source 418, and real-time data source 424 may be integrated as one source device. Although communications between sources 416, 418, and 424 with user equipment devices 402, 404, and 406 are shown as through communications network 414, in some embodiments, sources 416, 418, and 424 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server.

For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider.

Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Real-time data source 424 may be any source or equipment capable of providing real-time data to the media guidance application. Real-time data source 424 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Real-time data source 424 may be the originator of content (e.g., a television broadcaster, a Webcast provider, etc.) or may not be the originator of content (e.g., an on-demand content provider, an Internet provider of content of broadcast programs for downloading, etc.). Real-time data source 424 may include cable sources, satellite providers, on-demand providers, Internet providers, over-the-top content providers, or other providers of content. Real-time data source 424 may also include a remote media server used to store different types of content (including video content selected by a user), in a location remote from any of the user equipment devices.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

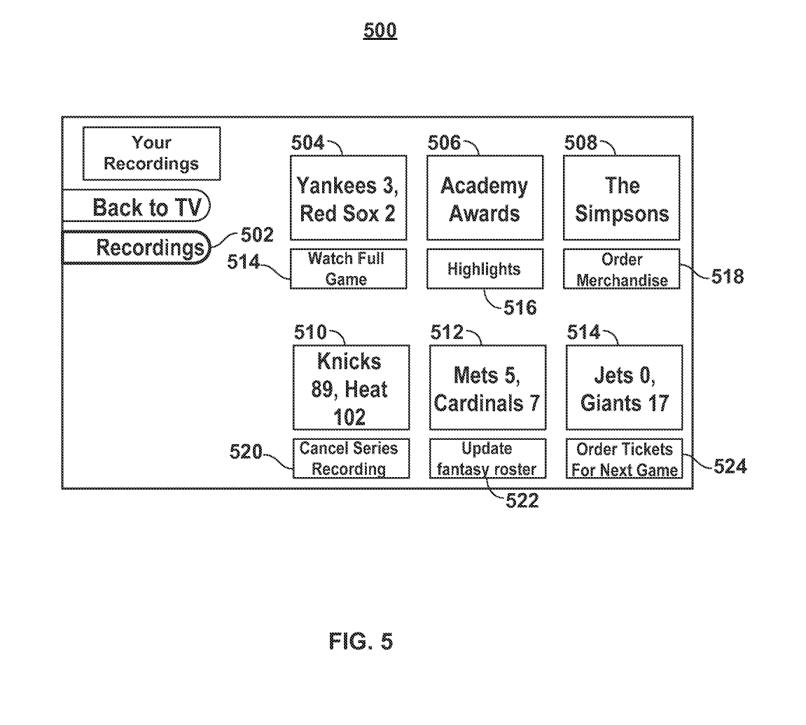

FIG. 5 is an illustrative representation of a display used to access content related to a media asset provided by the media guidance application in response to determining an outcome associated with the media asset. For example, a media guidance application (e.g., implemented on user device 300 (FIG. 3)) may generate display 500 for display (e.g., on display screen 312 (FIG. 3)). In some embodiments, the media guidance application may generate display 500 on a user equipment device 402, 404, and/or 406 (FIG. 4)).

Display 500 includes a plurality of media listings (e.g., listings 504, 506, 508, 510, 512, and 514) each associated with a media asset. In addition, display 500 also includes content related to a media asset (e.g., content 514, 516, 518, 520, 522, and 524) for each media listing. In some embodiments, display 500 may represent a menu page associated with program recordings. For example, in response to a user input (e.g., received via user input interface 310 (FIG. 3)), the media guidance application may store (e.g., on storage 308 (FIG. 3) or at a remote location accessible via communications network 414 (FIG. 4)) multiple media assets. For example, the media guidance application may allow (e.g., via control circuitry 304 (FIG. 3)) a user to schedule a recording of a media asset and/or access an on-demand media asset (e.g., streamed over the Internet).

In some embodiments, the media guidance application may automatically present content related to a media asset (e.g., without a user indication to record a media asset). For example, the media guidance application may determine to automatically generate, retrieve, etc. content related to a media asset based on occurrences in the, or associated with the, media asset. For example, the media guidance application may maintain a user profile (e.g., stored locally on storage 308 (FIG. 3) or remotely at any location accessible via communications network 414 (FIG. 4)). The media guidance application may retrieve user preferences (e.g., indicative of content a user may be interested in). The media guidance application may also monitor some or all of available media (e.g., received from media content source 416 (FIG. 4)). In response to detecting that content of the available media corresponds to the user preferences, the media guidance application may determine an outcome associated with the media asset. Based on the outcome and the use preferences, the media guidance application may present particular related content to the user.

For example, the media guidance application may detect (e.g., via processing circuitry 306 (FIG. 3)) that, as determined by a user profile, several friends of a user on a social network have posted comments related to a recent soap opera. In response the media guidance application may store a version of the soap opera for the user to view. Additionally or alternatively, the media guidance application (e.g., via processing circuitry 306 (FIG. 3)) may determine that a user, although somewhat interested in the soap opera because his/her friends are discussing it, is unlikely to wish to view the entire program. Accordingly, the media guidance application may present only highlights of the soap opera featuring the portion that is associated with the comments of his/her friends.

In some embodiments, the media guidance application may generate display 500 after a user has selected and/or navigated through (e.g., using inputs received via user input interface 310 (FIG. 3)) previous menus and/or sub-menus (e.g., via display 200 (FIG. 2)). In some embodiments, display 500 or any content related to a media asset may be presented by the media guidance application (e.g., on display 312 (FIG. 3)) in response to a user selecting a media asset. For example, in response to determining that a media asset has and/or is associated with related content, the media guidance application may generate a display of the related content (e.g., content 514, 516, 518, 520, 522, and 524) and/or an option to access the related content.

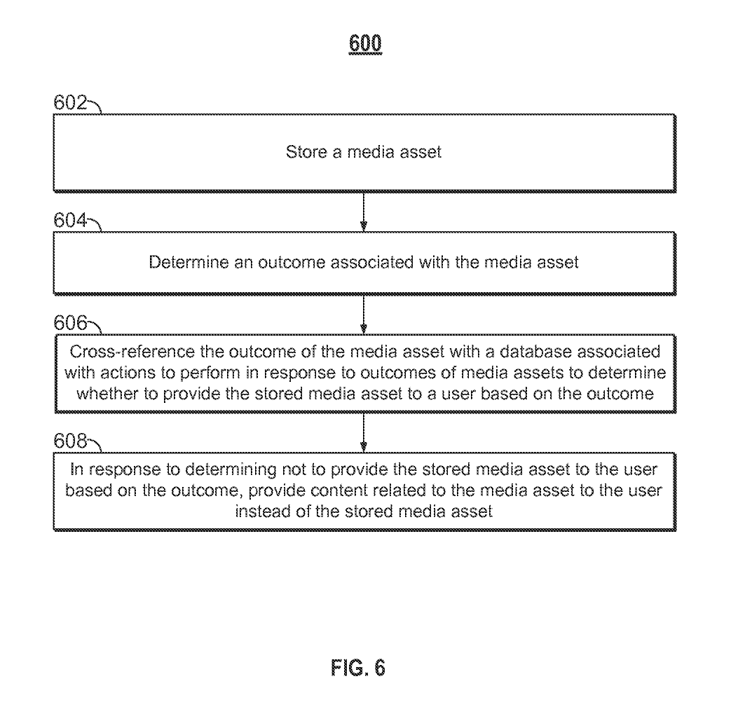

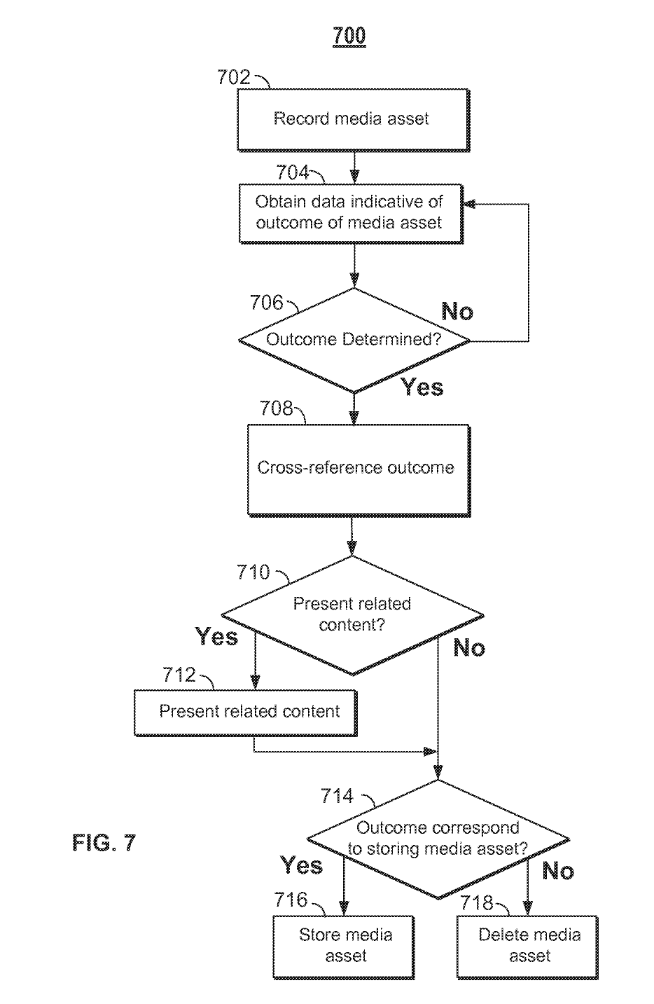

Display 500 includes a plurality of media listings (e.g., listings 504, 506, 508, 510, 512, and 514) each associated with a media asset and various forms of content related to a media asset (e.g., content 514, 516, 518, 520, 522, and 524). For example, listing 504 is associated with a media asset of a baseball game (e.g., a scored contest). In the baseball game, a participant (e.g., the “Yankees”) associated with the user (e.g., as indicated in a user profile stored locally on storage 308 (FIG. 3) or remotely at any location accessible via communications network 414 (FIG. 4)) has won the scored contest. In response, the media guidance application has determined (e.g., via a cross-reference with a database as discussed below in relation to FIGS. 6 and 7) particular content related to the media asset to present based on the outcome. In particular, the media guidance application has presented content 514, which corresponds to a recording of the entire media asset associated with listing 504.

In another example, listing 506 is associated with a media asset of an awards show (e.g., a scored contest). In the awards show, a participant (e.g., a favorite actor of the user) associated with the user (e.g., as indicated in a user profile stored locally on storage 308 (FIG. 3) or remotely at any location accessible via communications network 414 (FIG. 4)) has won (e.g., won an award) the scored contest. In response, the media guidance application has determined (e.g., via a cross-reference with a database as discussed below in relation to FIGS. 6 and 7) particular content related to the media asset to present based on the outcome. In particular, the media guidance application has presented content 514, which corresponds to highlights of the media asset associated with listing 506 (e.g., showing only portions of the media asset associated with the favorite actor of the user).

In another example, listing 508 is associated with a media asset of a comedy show (e.g., a non-scored contest). In the comedy show, an event (e.g., an appearance of a favorite guest character) associated with the user (e.g., as indicated in a user profile stored locally on storage 308 (FIG. 3) or remotely at any location accessible via communications network 414 (FIG. 4)) has appeared in the non-scored contest. In response, the media guidance application has determined (e.g., via a cross-reference with a database as discussed below in relation to FIGS. 6 and 7) particular content related to the media asset to present based on the occurrence of the event. In particular, the media guidance application has presented content 518, which corresponds to merchandise associated with the guest character's appearance on the show.

In another example, listing 510 is associated with a media asset of a basketball game (e.g., a scored contest). In the basketball game, a participant (e.g., a favorite team of the user) associated with the user (e.g., as indicated in a user profile store locally on storage 308 (FIG. 3) or remotely at any location accessible via communications network 414 (FIG. 4)) has lost the scored contest. In response, the media guidance application has determined (e.g., via a cross-reference with a database as discussed below in relation to FIGS. 6 and 7) particular content related to the media asset to present based on the outcome. In particular, the media guidance application has presented content 520, which corresponds to an option to edit media guidance application functions associated with the media asset associated with listing 520 (e.g., cancel the series recording of the media asset).

In another example, listing 512 is associated with a media asset of a baseball game (e.g., a scored contest). In the baseball game, a participant (e.g., a player on a fantasy sports roster) associated with the user (e.g., as indicated in a user profile stored locally on storage 308 (FIG. 3) or remotely at any location accessible via communications network 414 (FIG. 4)) has earned points (e.g., points in the fantasy sports contest) in the scored contest. In response, the media guidance application has determined (e.g., via a cross-reference with a database as discussed below in relation to FIGS. 6 and 7) particular content related to the media asset to present based on the outcome. In particular, the media guidance application has presented content 522, which corresponds to an option to update a fantasy sports roster associated with the user.

Finally, listing 514 is associated with a media asset of a football game (e.g., a scored contest). In the football game, a participant (e.g., a favorite team of the user) associated with the user (e.g., as indicated in a user profile stored locally on storage 308 (FIG. 3) or remotely at any location accessible via communications network 414 (FIG. 4)) has won the scored contest. In response, the media guidance application has determined (e.g., via a cross-reference with a database as discussed below in relation to FIGS. 6 and 7) particular content related to the media asset to present based on the outcome. In particular, the media guidance application has presented content 524, which corresponds to an option to purchase tickets for the next game associated with the participant.

It should be noted that the examples discussed with relation to FIG. 5 are illustrative only. Additional options, related content, etc. may be shown for each media listing (e.g., multiple types of related content for each listing) in some embodiments.

FIG. 6 is a flowchart of illustrative steps involved in providing content related to the media asset to the user based on an outcome of the media asset. It should be noted that process 600 or any step thereof, could be performed on, or provided by, any of the devices shown in FIGS. 3-4. For example, process 600 may be executed by control circuitry 304 (FIG. 3) as instructed by a media guidance application implemented on user equipment 402, 404, and/or 406 (FIG. 4) in order to provide content related to the media asset to the user based on an outcome of the media asset (e.g., as discussed in relation to FIG. 5). In addition, one or more steps of process 600 may be incorporated into or combined with one or more steps of process 700 (FIG. 7).

At step 602, the media guidance application stores a media asset. For example, in response to a user request (e.g., received via user input interface 310 (FIG. 3)) selects a media asset for recording, the media guidance application (e.g., via control circuitry 304 (FIG. 3)) records the media asset (e.g., at storage 308 (FIG. 3)). In another example, the media guidance application may retrieve (e.g., via I/O path 302 (FIG. 3)) a media asset available from a remote source (e.g., media content source 416 (FIG. 4) and/or any location accessible via communications network 414 (FIG. 4)).

At step 604, the media guidance application determines an outcome associated with the media asset. For example, the media guidance application may determine (e.g., via processing circuitry 306 (FIG. 3)) which participant in a scored contest (e.g., a beauty pageant) won the contest. In another example, the media guidance application may determine that a particular event (e.g., a plot twist) occurred in a non-scored contest (e.g., a television drama).

To determine the outcome associated with the media asset, the media guidance application may receive real-time data (e.g., via I/O path 302 (FIG. 3)) from a remote source (e.g., real-time data source 424 (FIG. 4)). The real-time data may indicate a score, occurrence of an event, and/or any other information (e.g., social network comments, critic reviews, ratings information, etc.) associated with the media asset.

Alternatively or additionally, the media guidance application may receive data transmitted with the media asset (e.g., metadata) from a source (e.g., media content source 416 (FIG. 4)) of the media asset. The data may also indicate a score, occurrence of an event, and/or any other information (e.g., social network comments, critic reviews, ratings information, etc.) associated with the media asset.

Additionally or alternatively, the media guidance application may process the media asset to determine an outcome of the media asset. For example, the media guidance application may include and/or have access to one or more content recognition modules. A content recognition module may use edge detection, pattern recognition, including, but not limited to, self-learning systems (e.g., neural networks), optical character recognition, on-line character recognition (including, but not limited to, dynamic character recognition, real-time character recognition, intelligent character recognition), and/or any other suitable technique or method to identify content associated with an outcome of and/or an event in a media asset. For example, the media guidance application may receive a media asset in the form of a video (e.g., an audio/video recording of a user). The video may include a series of frames. For each frame of the video, the media guidance application may use an object recognition module to identify objects in the frame (e.g., an on-screen scoreboard). In some embodiments, the content recognition module or algorithm may also include audio analysis and speech recognition techniques, including, but not limited to, Hidden Markov Models, dynamic time warping, and/or neural networks (as described above) to process audio data and/or translate spoken words into text in order to identify objects (e.g., a ring announcer declaring the winner of a boxing match).

In addition, the media guidance application may use multiple types of optical character recognition and/or fuzzy logic, for example, when analyzing subtitles (e.g., in order to determine the appearance of a particular character in the media asset) or comparing multiple data fields (e.g., as contained in databases described herein). Using fuzzy logic, the system may determine two fields and/or values to be identical even though the substance of the data field or value (e.g., two different spellings) is not identical. For example, in some embodiments, the system may analyze particular data fields of a database (e.g., a field associated with favorite actors of a user found in a user profile) for particular values or text (e.g., names of the current characters appearing in a media asset). Furthermore, the data fields could contain values (e.g., the data fields could be expressed in binary or any other suitable code or programming language) other than human-readable text. Based on the comparison, the media guidance application may (e.g., via processing circuitry 306 (FIG. 3)) determine an event or an outcome in the media asset.

At step 606, the media guidance application cross-references the outcome of the media asset with a database associated with actions to perform in response to outcomes of media assets to determine whether to provide the stored media asset to a user based on the outcome. For example, the media guidance application may input one or more outcomes and/or events into a database (e.g., stored locally at storage 308 (FIG. 3) or remotely at any location accessible via communications network 414 (FIG. 4)). The media guidance application (e.g., via control circuitry 304 (FIG. 3)) may also input user preferences (e.g., indicating which participant in a scored contest is favored by a user, significance of a scored contest, and/or any other relevant information) into the database.

For example, the database may be structured as a look up table. For each of the one or more inputs, the database may determine one or more fields that correspond to the input. Some of those fields may correspond to an action to take based on the outcome. For example, for a particular type of media asset (e.g., a baseball game), the database may indicate actions to take if the outcome involves a favorite team of the user. Additionally or alternatively, the database may indicate actions to take if the outcome does not involve a favorite team of the user.

Additionally or alternatively, the database may include actions to take if the outcome of the game relates to a particular team (e.g., a favorite team of the user) winning (e.g., record the entire game and/or generate highlights of the game). Likewise, the database may include different actions to take if the outcome of the game relates to a different team (e.g., a non-favorite team of the user) winning (do not record the entire game and/or do generate highlights).

The particular outcomes indicated in the database may be based on user selections. For example, prior to use, the user (e.g., via user input interface 310 (FIG. 3)) may indicate one or more actions (e.g., via a display linked to display 500 (FIG. 5)) to take based on the outcome of the user. Additionally or alternatively, the media guidance application may determine an action to take based on previous user actions related to similar media assets and/or outcomes and/or third party instructions (e.g., received from any source accessible via communications network 414 (FIG. 4)). For example, the media guidance application may receive instructions to generate highlights for a particular team (e.g., a local team) for each user determined (e.g., via information in a user profile) to be within a particular geographic area.

At step 608, the media guidance application in response to determining not to provide the stored media asset to the user based on the outcome, provides content related to the media asset to the user instead of the stored media asset. For example, the media guidance application may have initially received a user request (e.g., entered via user input interface 310 (FIG. 3)) to record a media asset. However, in response to determining a particular outcome of the media asset (e.g., a preferred participant of the user losing a scored contest), the media guidance application may determine a different action (e.g., delete the recording the media asset and/or generate highlights of the media asset) to perform. Additionally or alternatively, the media guidance application may (e.g., via control circuitry 304 (FIG. 3)) present content related to the media asset based on the outcome (e.g., content 514, 516, 518, 520, 522, and/or 524 (FIG. 5)).

In some embodiments, the media guidance application may generate the related content (e.g., highlights of a scored contest) in numerous ways. For example, the media guidance application may receive the related content from a remote source (e.g., media content source 416 (FIG. 4), real-time data source 424 (FIG. 4), and/or any location accessible from communications network 414 (FIG. 4)) or local source (e.g., storage 308 (FIG. 3), may generate the related content locally (e.g., using a content recognition module), and/or may obtain the related content using any other suitable method.

For example, in response to determining not to provide the stored media asset to the user based on the outcome, the media guidance application may query the remote source for content related to the media asset. Additionally, the media guidance application may query the remote source for a particular type of related content to generate for display. For example, in addition to determining whether or not to provide the media asset to the user, the media guidance application may additionally receive instructions as to whether or not to generate a display of related content and/or the type of related content to display based on the cross-reference.

For example, based on the outcome and/or user preferences associated with the media asset, the database may indicate that particular related content should be presented to the user. If the output of the database indicates that a highlight of the media asset should be shown, the media guidance application may query (e.g., using control circuitry 304 (FIG. 3)), a remote source for a highlight of the media asset. In some embodiments, the media guidance application may additionally or alternatively, retrieve a highlight or other related content from local storage (e.g., storage 308 (FIG. 3)).

In some embodiments, the media guidance application may generate the related content locally. For example, in response to determining that a highlight of a media asset should be presented to a user, the media guidance application may (e.g., via processing circuitry 306 (FIG. 3)) determine the most relevant portions (e.g., based on data associated with the media asset and/or user preferences) of the media asset and present those portions to the user. For example, using the content recognition module discussed above, the media guidance application may determine when a particular player (e.g., indicated by a user profile as being a favorite player of the user) appears in the media asset and/or relevant portions (e.g., scoring plays) of a media asset occurs. The media guidance application may then crop the media asset accordingly. The media guidance application may then store (e.g., at storage 308 (FIG. 3)) the generated related content until it is presented to the user.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 6.

FIG. 7 is a flowchart of illustrative steps involved determining content related to a media asset to present to a user in response to determining an outcome of the media asset. It should be noted that process 700 or any step thereof, could be performed on, or provided by, any of the devices shown in FIGS. 3-4. For example, process 700 may be executed by control circuitry 304 (FIG. 3) as instructed by a media guidance application implemented on user equipment 402, 404, and/or 406 (FIG. 4) in order to determine content related to a media asset to present to a user in response to determining an outcome of the media asset (e.g., as discussed in relation to FIG. 5). In addition, one or more steps of process 700 may be incorporated into or combined with one or more steps of process 600 (FIG. 6).

At step 702, the media guidance application records a media asset. For example, in response to a user request (e.g., entered via user input interface 310 (FIG. 3)) to record a program, in response to detecting an episode of a serial program a user has previously indicated to record, and/or an automatic recording (e.g., based on an outcome and/or event in a media asset as discussed above), the media guidance application may (e.g., via control circuitry 304 (FIG. 4)) record the media asset (e.g., on storage 308 (FIG. 3) on user equipment device 402, 404, and/or 406 (FIG. 4)).

At step 704, the media guidance application obtains data indicative of the outcome of the media asset. For example, the media guidance application (e.g., via processing circuitry 306 (FIG. 3)) may detect data (e.g., metadata) transmitted with the media asset indicating the outcome of and/or events in the media asset, may receive (e.g., I/O path 302 (FIG. 3)) real-time data indicating the outcome of and/or events in the media asset, may process the media asset to determine the outcome of and/or events in the media asset, and/or may user any other suitable method for determining an outcome of a media asset.

At step 706, the media guidance application determines whether an outcome of the media asset is determined. For example, the media guidance application (e.g., via processing circuitry 306 (FIG. 3)) the data (e.g., metadata) transmitted with the media asset, the real-time data indicating the outcome of and/or events in the media asset, results of processing the media asset to determine the outcome of and/or events in the media asset, and/or results of any other suitable method for determining an outcome of a media asset may indicate that the media asset is still on-going (e.g., a baseball game is still in progress).

If the media guidance application determines (e.g., via processing circuitry 306 (FIG. 3)) that the outcome is not determined, the media guidance application returns to step 704 and continues to obtain data indicative of outcome of media asset. For example, the media guidance application may periodically or continuously analyze the data transmitted with the media asset, poll a source of real-time data, and/or process the media assets until an outcome is determined. If the media guidance application determines (e.g., via processing circuitry 306 (FIG. 3)) that the outcome is determined, the media guidance application proceeds to step 706 and cross-references the outcome with a database.

At step 708, the media guidance application cross-references the outcome. For example, in some embodiments, step 708 may correspond to step 606 (FIG. 6). For example, the media guidance application may input one or more outcomes and/or events into a database (e.g., stored locally at storage 308 (FIG. 3) or remotely at any location accessible via communications network 414 (FIG. 4)). The inputs may correspond to the outcome of the media asset. For example, the media guidance application may indicate that for a particular media asset (e.g., a football game) that the outcome of the media asset (e.g., the outcome of the football game) was highly competitive (e.g., the final score, based on the scoring rules of the game, between the participants was close). Based on the inputted outcome, the database may determine one or more actions to perform.

For example, at step 710, the media guidance application determines whether or not to present related content based on the cross-reference. For example, based on cross-referencing the outcome of the game, and/or the fact that the game was highly competitive, the media guidance application may determine to present highlights, present options related to merchandise for the game, present options to order tickets for the next game, present options (or automatically post) the media asset to a social network, etc.

Additionally or alternatively, other information may also affect whether or not related content is presented and/or the type of related content presented. For example, information (e.g., retrieved from a user profile stored at storage 308 (FIG. 3)) indicating a favorite team of the user won may affect the related content that is generated. In some embodiments, the other information may be accounted for during the cross-reference (e.g., the media guidance application may input the additional information into the database) and/or the other information may be accounted for by the media guidance application after the cross-reference.

For example, the media guidance application may determine (e.g., via processing circuitry 306 (FIG. 3)) an outcome of a media asset. The media guidance application may also generate a display (e.g., on display 312 (FIG. 3)) of the outcome (e.g., a final score of the game). The media guidance application may also generate a display of options to perform (e.g., associated with related content that may be received, generated, retrieved, etc.) based on the outcome. For example, the media guidance application may (e.g., via control circuitry 304 (FIG. 3)) indicate that a user's favorite team won. In response, the media guidance application may query the user as to whether or not the user would like related content (and/or types of related content) generated for display by the media guidance application.

If the media guidance application determines to present related content at step 710, the media guidance application proceeds to step 712 and generates one or more types of related content (e.g., as shown and described in relation to display 500 (FIG. 5)). If the media guidance application determines not to present related content at step 710, the media guidance application proceeds to step 714.

At step 714, the media guidance application determines whether or not to store the recording of the media asset. For example, the media guidance application may determine (e.g., via control circuitry 304 (FIG. 3)), for example, based on the output of the cross-reference, that the recording of the media asset should be deleted (e.g., based on the outcome it is unlikely that the user would wish to view the media asset). Accordingly, the media guidance application proceeds to step 718 and deletes the media asset. In such cases, only the related content, if any, received, retrieved, generated, etc. at step 712 may be presented to a user (e.g., on display 500 (FIG. 5)).

Alternatively, the media guidance application may determine (e.g., via control circuitry 304 (FIG. 3)), for example, based on the output of the cross-reference, that the recording of the media asset should not be deleted (e.g., based on the outcome it is likely that the user would wish to view the media asset). Accordingly, the media guidance application proceeds to step 716 and stores the media asset. In such cases, the related content, if any, received, retrieved, generated, etc. at step 712 may be presented to a user with the recording of the media asset (e.g., on display 500 (FIG. 5)).

It is contemplated that the steps or descriptions of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 7.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for providing media content based on occurrences in the media content, the method comprising:
storing a media asset;
determining an outcome associated with the media asset;
cross-referencing the outcome with a database associated with actions to perform in response to outcomes of media assets to determine whether to provide the stored media asset to a user based on the outcome; and
in response to determining not to provide the stored media asset to the user based on the outcome, providing content related to the media asset to the user instead of the stored media asset.

2. The method of claim 1, wherein the content related to the media asset includes highlights associated with the media asset.

3. The method of claim 1 further comprising receiving a user request to store the media asset.

4. The method of claim 1 further comprising selecting the actions to perform in response to outcomes of media assets in the database based on a user profile.

5. The method of claim 1 further comprising receiving information related to the outcome transmitted with the media asset.

6. The method of claim 1 further comprising receiving a real-time data feed associated with the media asset, wherein the real-time data feed indicates the outcome.

7. The method of claim 1 further comprising:
processing the media asset using a content recognition module to determine information related to the outcome; and
determining the outcome based on the information related to the outcome.

8. The method of claim 1, wherein the media asset is a non-scored contest, and wherein the outcome relates to an occurrence of an event in the non-scored contest.

9. The method of claim 1, wherein the media asset is a scored contest, and wherein the outcome relates to whether a participant is victorious in the scored contest.

10. The method of claim 1 further comprising in response to determining to provide the stored media asset to the user based on the outcome, providing the stored media asset and the content related to the media asset to the user.

11. A system for providing media content based on occurrences in the media content, the system comprising control circuitry configured to:
store a media asset;
determine an outcome associated with the media asset;
cross-reference the outcome with a database associated with actions to perform in response to outcomes of media assets to determine whether to provide the stored media asset to a user based on the outcome; and
in response to determining not to provide the stored media asset to the user based on the outcome, provide content related to the media asset to the user instead of the stored media asset.

12. The system of claim 11, wherein the content related to the media asset includes highlights associated with the media asset.

13. The system of claim 11, wherein the control circuitry is further configured to receive a user request to store the media asset.

14. The system of claim 11, wherein the control circuitry is further configured to select the actions to perform in response to outcomes of media assets in the database based on a user profile.

15. The system of claim 11, wherein the control circuitry is further configured to receive information related to the outcome transmitted with the media asset.

16. The system of claim 11, wherein the control circuitry is further configured to receive a real-time data feed associated with the media asset, wherein the real-time data feed indicates the outcome.

17. The system of claim 11, wherein the control circuitry is further configured to:
process the media asset using a content recognition module to determine information related to the outcome; and
determine the outcome based on the information related to the outcome of the media asset.

18. The system of claim 11, wherein the media asset is a non-scored contest, and wherein the outcome relates to an occurrence of an event in the non-scored contest.

19. The system of claim 11, wherein the media asset is a scored contest, and wherein the outcome relates to whether a participant is victorious in the scored contest.

20. The system of claim 11, wherein the control circuitry is further configured to provide the stored media asset and the content related to the media asset to the user in response to determining to provide the stored media asset to the user based on the outcome.

21-40. (canceled)
